(19) United States
(12) Patent Application Publication
(10) Pub. No.: US 2022/0272803 A1
(43) Pub. Date: Aug. 25, 2022

(54) LED CONTROL CIRCUIT AND DEVICE COMPATIBLE WITH SILICON-CONTROLLED DIMMER, AND CONTROL METHOD

(71) Applicant: SHENZHEN SENDIS SEMICONDUCTOR CO., LTD, Shenzhen (CN)

(72) Inventors: YU' AN YE, SHENZHEN (CN); XUNSHENG DENG, SHENZHEN (CN); BO CHEN, SHENZHEN (CN)

(21) Appl. No.: 17/634,878

(22) PCT Filed: Aug. 13, 2020
(86) PCT No.: PCT/CN2020/108934

§ 371 Date: Feb. 11, 2022

(30) Foreign Application Priority Data
Aug. 14, 2019 (CN) 201910750798.4

(51) Int. Cl. H05B 45/14; H05B 45/345; H05B 45/3575

(52) U.S. Cl. CPC H05B 45/14; H05B 45/345; H05B 45/3575

(57) ABSTRACT

Disclosed are an LED control circuit and device compatible with a silicon-controlled dimmer, and a control method. The LED control circuit comprises a silicon-controlled dimmer, a rectifier module, a bleeder module, a control module, a voltage detection module, and a constant-current source module. An alternating current is input to the silicon-controlled dimmer and the rectifier module and then a line voltage is output to the voltage detection module; the voltage detection module outputs a voltage detection signal to the control module according to the change of the line voltage and outputs a phase angle detection signal to the constant-current source module; the control module controls on or off of the bleeder module according to the voltage detection signal, and a bleeder current when the bleeder module is turned on is greater than a maximum charging current before the silicon-controlled dimmer is conducted.

### FIELD OF THE DISCLOSURE

The present disclosure relates to the field of LED (Light Emitting Diode) technology, in particular to an LED control circuit and a device compatible with silicon-controlled dimmer, and a control method.

### BACKGROUND

As shown in FIG. 1, FIG. 2 and FIG. 3, in the present LED control circuit using silicon-controlled dimming, when a voltage flowing through the LED lamp string is less than a lighting voltage of the LED lamp string, the LED lamp string does not light up, a current flowing through the LED lamp string is less than a current set by the discharge circuit part, and then the discharge circuit part will immediately be on and enter a working state to form a current circuit. However, the current in this part of circuit is not used for the lighting of the LED lamp string, resulting in a low luminous efficiency of the LED lamp string. In addition, when the silicon-controlled dimmer is dimmed to a small phase angle, the silicon-controlled dimmer is on, but the MOS (Metal-Oxide-Semiconductor) transistor Q11 is in the linear region, i.e., an on-voltage of the silicon-controlled dimmer is linear with an on-current, the on-current is greatly affected by the on-voltage. If the on-voltage is inconsistent, the LED lamp string will flicker.

Therefore, the existing technology needs to be developed.

### BRIEF SUMMARY OF THE DISCLOSURE

In view of above shortcomings of prior art, the purpose of the present disclosure is to provide an LED control circuit and a device compatible with silicon-controlled dimmer, and a control method, which can assure the discharge circuit not be on immediately when the LED lamp string is no longer lit, so as to improve a luminous efficiency of the LED lamp string, and also solve a problem of small phase angle lamp flicker when the LED lamp string is lit.

To achieve the above-mentioned purpose, the present disclosure adopts the following technical scheme:

An LED control circuit compatible with a silicon-controlled dimmer which is connected with an LED lamp string, the circuit includes a silicon-controlled dimmer, a rectifier module, a discharge module, a control module, a voltage detection module and a constant current source module. An input AC (alternating current) is performed phase cutting and rectification processing by the silicon-controlled dimmer and the rectifier module, and then a line voltage is output to the voltage detection module. The voltage detection module is configured to output a voltage detection signal to the control module according to a change of the line voltage, and output a phase angle detection signal to the constant current source module. The control module is configured to control an on or off of the discharge module according to the voltage detection signal, and when the discharge module is on the discharge current is greater than a charging current which is a maximum charging current before the silicon-controlled dimmer is turned on. The constant current source module is configured to constant current drive the LED lamp string when the line voltage is greater than an on-voltage of the LED lamp string, and adjust a constant current value according to the phase angle detection signal.

In the LED control circuit compatible with silicon-controlled dimmer, the control module is configured to control the discharge module to be turned on when the voltage detection signal is less than a second threshold voltage, control the discharge module to be turned off when the voltage detection signal is greater than the second threshold voltage, and when the voltage detection signal is again less than a first threshold voltage, control the discharge module to be turned on. The first threshold voltage is less than or equal to the second threshold voltage.

In the LED control circuit compatible with the silicon-controlled dimmer, the voltage detection module includes a voltage detection unit and a phase angle detection unit, and the voltage detection unit is configured to output the voltage detection signal to the control module according to the change of the line voltage. The phase angle detection unit is configured to output the phase angle detection signal to the constant current source module according to the change of the line voltage.

In the LED control circuit compatible with silicon-controlled dimmer, the voltage detection unit includes a first resistor and a second resistor, one end of the first resistor is connected with the rectifier module and the LED lamp string, another end of the first resistor is connected with one end of the second resistor and the control module, and another end of the second resistor is grounded.

In the LED control circuit compatible with silicon-controlled dimmer, the phase angle detection unit includes a third resistor, a fourth resistor and a first capacitor, one end of the third resistor is connected with one end of the first resistor, the LED lamp string and the rectifier module, and another end of the third resistor is connected with one end of the fourth resistor, one end of the first capacitor and the constant current source module, and another end of the fourth resistor and another end of the first capacitor are grounded.

In the LED control circuit compatible with silicon-controlled dimmer, the control module includes a first operational amplifier and a first MOS transistor, a non-invert input end of the first operational amplifier is connected with the other end of the first resistor and one end of the second resistor, an invert input end of the first operational amplifier is connected with a power supply end, an output end of the first operational amplifier is connected with a gate of the first MOS transistor, a drain of the first MOS transistor is connected with the discharge module, and a source of the first MOS transistor is grounded.

In the LED control circuit compatible with silicon-controlled dimmer, the discharge module includes a second operational amplifier, a second MOS transistor and a fifth resistor, a non-invert input end of the second operational amplifier is connected with a power supply, and an invert input end of the second operational amplifier is connected with a source of the second MOS transistor and one end of the fifth resistor, an output end of the second operational amplifier is connected with a gate of the second MOS transistor and the drain of the first MOS transistor, and another end of the fifth resistor is grounded.

In the LED control circuit compatible with silicon-controlled dimmer, the constant current source module includes a third operational amplifier, a third MOS transistor and a sixth resistor, a non-invert input end of the third operational amplifier is connected with the other end of the third resistor, the one end of the fourth resistor and the one end of the first capacitor, an invert input end of the third operational amplifier is connected with a source of the third MOS transistor and one end of the sixth resistor, an output end of the third operational amplifier is connected with a gate of the third MOS transistor, a drain of the third MOS transistor is connected with the LED lamp string, and another end of the sixth resistor is grounded.

An LED control method compatible with silicon-controlled dimmer comprises the following steps:

Sending a line voltage to a voltage detection module after an input AC is performed phase cutting and rectification processing by the silicon-controlled dimmer and rectifier module;

Outputting a voltage detection signal to the control module from the voltage detection module according to a change of the line voltage, and outputs a phase angle detection signal to the constant current source module;

Controlling an on or off of a discharge module by the control module according to the voltage detection signal, and when the discharge module is on a discharge current is greater than a charging current which is a maximum charging current before the silicon-controlled dimmer is turned on;

Constant current driving the LED lamp string by the constant current source module when the line voltage is greater than an on-voltage of the LED lamp string, and adjusting a constant current value according to the phase angle detection signal.

An LED control device compatible with silicon-controlled dimmer includes a shell, a PCB (Printed Circuit Board) arranged in the shell, and an LED control circuit compatible with silicon-controlled dimmer as described above arranged on the PCB.

Compared with prior art, the LED control circuit and the device compatible with silicon-controlled dimmer, and the control method provided by the present disclosure includes a silicon-controlled dimmer, a rectifier module, a discharge module, a control module, a voltage detection module and a constant current source module, an input AC is performed phase cutting and rectification processing by the silicon-controlled dimmer and the rectifier module, and then the output line voltage is sent to the voltage detection module. The voltage detection module is used for outputting a voltage detection signal to the control module according to the change of the line voltage, and outputting a phase angle detection signal to the constant current source module. The control module is configured to control an on or off of the discharge module according to the voltage detection signal, and when the discharge module is on a discharge current is greater than the charging current which is the maximum charging current before the silicon-controlled dimmer is turned on. The constant current source module is used for constant current driving the LED lamp string when the line voltage is greater than an on-voltage of the LED lamp string, and adjusting the constant current value according to the phase angle detection signal. The present disclosure can make a discharge circuit not be on immediately when the LED lamp string is no longer lit, so as to improve a luminous efficiency of the LED lamp string. At the same time, it can also solve a problem of small phase angle lamp flicker when the LED lamp string is lit.

### BRIEF DESCRIPTION OF THE DRAWINGS

FIG. 1 is a circuit schematic diagram of a prior LED control circuit;

FIG. 2 is a waveform diagram of the line voltage when the silicon-controlled dimmer is dimmed to a large phase angle in the prior LED control circuit;

FIG. 3 is a waveform diagram of the line voltage when the silicon-controlled dimmer is dimmed to a small phase angle in the prior LED control circuit;

FIG. 4 is a circuit block diagram of an LED control circuit compatible with a silicon-controlled dimmer provided by the present disclosure;

FIG. 5 is a waveform diagram of the line voltage when the silicon-controlled dimmer is dimmed to a large phase angle in the LED control circuit compatible with the silicon-controlled dimmer provided by the present disclosure;

FIG. 6 is a waveform diagram of the line voltage when the silicon-controlled dimmer is dimmed to a small phase angle in the LED control circuit compatible with the silicon-controlled dimmer provided by the present disclosure;

FIG. 7 is an equivalent diagram of a silicon-controlled dimmer in an LED control circuit compatible with a silicon-controlled dimmer provided by the present disclosure;

FIG. 8 is an equivalent diagram before the silicon-controlled dimmer is turned on in the LED control circuit compatible with the silicon-controlled dimmer provided by the present disclosure;

FIG. 9 is a circuit schematic diagram of an LED control circuit compatible with a silicon-controlled dimmer provided by a first embodiment of the present disclosure;

FIG. 10 is a circuit schematic diagram of an LED control circuit compatible with a silicon-controlled dimmer provided by a second embodiment of the present disclosure;

FIG. 11 is a circuit schematic diagram of an LED control circuit compatible with a silicon-controlled dimmer provided by a third embodiment of the present disclosure;

FIG. 12 is a circuit schematic diagram of an LED control circuit compatible with a silicon-controlled dimmer provided by a fourth embodiment of the present disclosure;

FIG. 13 is a flowchart of an LED control method compatible with a silicon-controlled dimmer provided by the present disclosure.

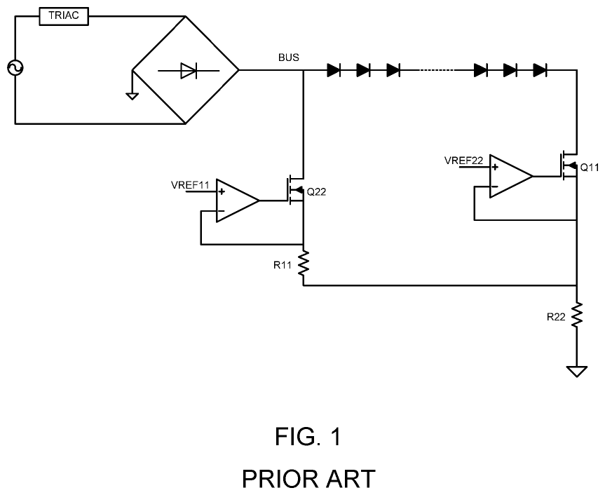

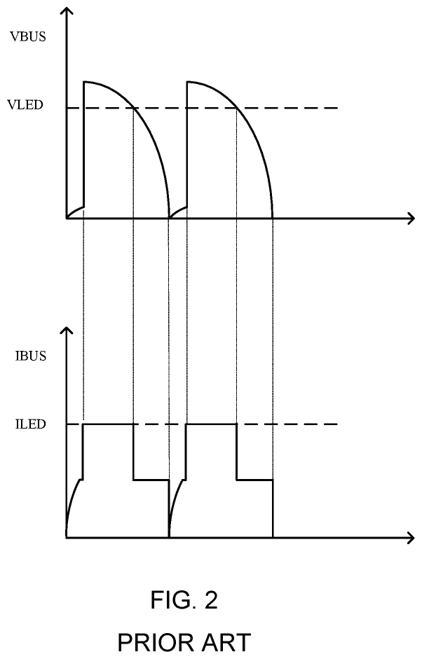

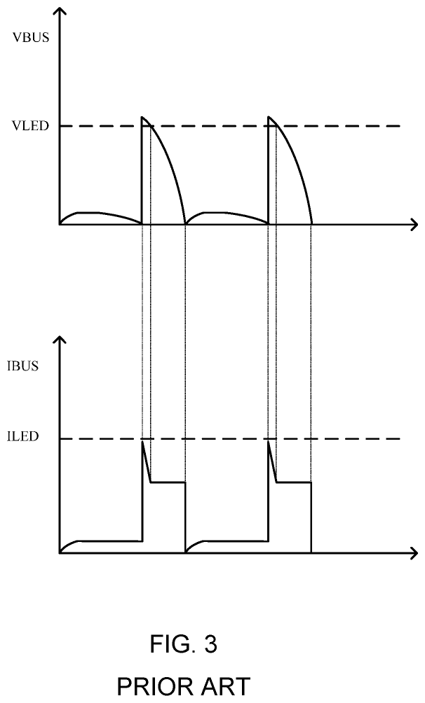

### DETAILED DESCRIPTION OF EMBODIMENTS

The purpose of the present disclosure is to provide an LED control circuit and a device compatible with silicon-controlled dimmer, and control method, which can make the discharge circuit not be on immediately when the LED lamp string is no longer lit, so as to improve the luminous efficiency of the LED lamp string, and solve the problem of small phase angle lamp flicker when the LED lamp string is lit.

In order to make the object, technical scheme and effect of the present disclosure dearer and more definite, the present disclosure is further described in detail with reference to the attached drawings and embodiments. The embodiments described herein are only configured to explain the present disclosure and are not considered to limit the present disclosure.

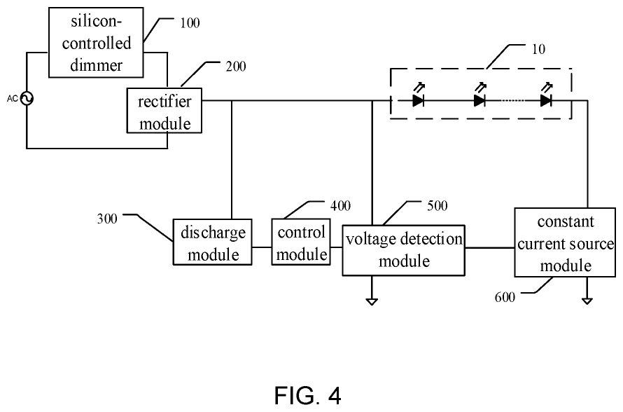

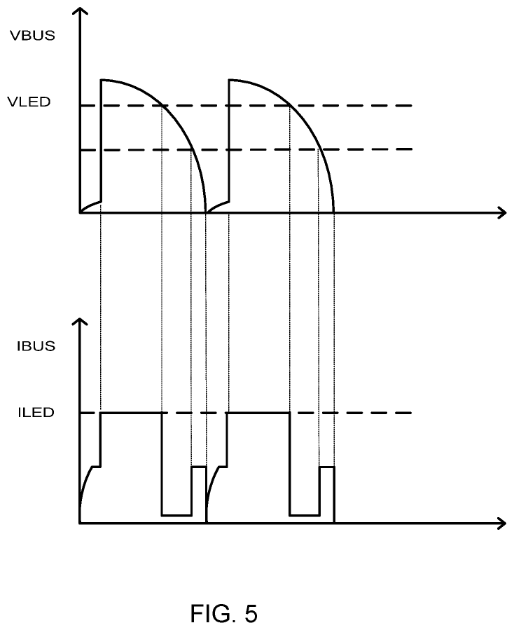

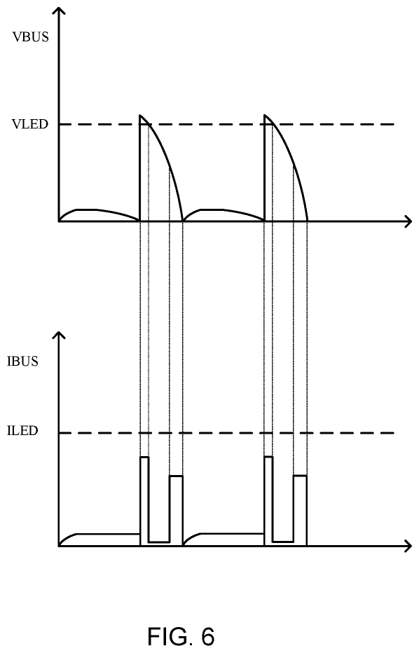

Referring to FIGS. 4, 5 and 6, an LED control circuit compatible with silicon-controlled dimmer 100 provided by the present disclosure is connected with an LED lamp string 10, including a silicon-controlled dimmer 100, a rectifier module 200, a discharge module 300, a control module 400, a voltage detection module 500 and a constant current source module 600. The silicon-controlled dimmer 100 is connected between an AC input end and an input end of the rectifier module 200 to perform phase cutting on the input AC, an output end of the rectifier module 200 is connected with the discharge module 300, the voltage detection module 500 and the LED lamp string 10, the discharge module 300 is also connected with the voltage detection module 500 through the control module 400, the voltage detection module 500 is also connected with the constant current source module 600, and the constant current source module 600 is further connected with the LED lamp string 10.

In the present disclosure, the rectifier module 200 rectifies and converts the AC has been performed phase cutting into DC, then outputs a line voltage on a DC bus to the voltage detection module 500 and the LED lamp string 10. The voltage detection module 500 outputs a voltage detection signal V1 to the control module 400 according to a change of the line voltage. Further, the control module 400 controls an on or off of the discharge module 300 according to the voltage detection signal V1, and when the discharge module 300 is on the discharge current is greater than the charging current which is the maximum charging current before the silicon-controlled dimmer 100 is turned on, that is, the control module 400 controls a corresponding working state of the discharge module 300 after meeting a plurality of preset conditions according to the voltage detection signal V1, to achieve the effect of improving the luminous efficiency of the LED lamp string 10. When the line voltage is less than an on-voltage of the LED lamp string 10, the DC bus current is discharged by the discharge module 300 to maintain the operation of the silicon-controlled. The voltage detection module 500 detects a phase angle information of the silicon-controlled dimmer 100 and output a corresponding phase angle detection signal V2 to the constant current source module 600, so that a constant current value can be adjusted according to the phase angle detection signal V2 during the constant current driving by the constant current source module 600 of the LED lamp string 10 when the line voltage is greater than the on-voltage of the LED lamp string 10. The influence of the on-voltage of the silicon-controlled dimmer 100 is reduced, so as to solve the problem of small phase angle lamp flicker.

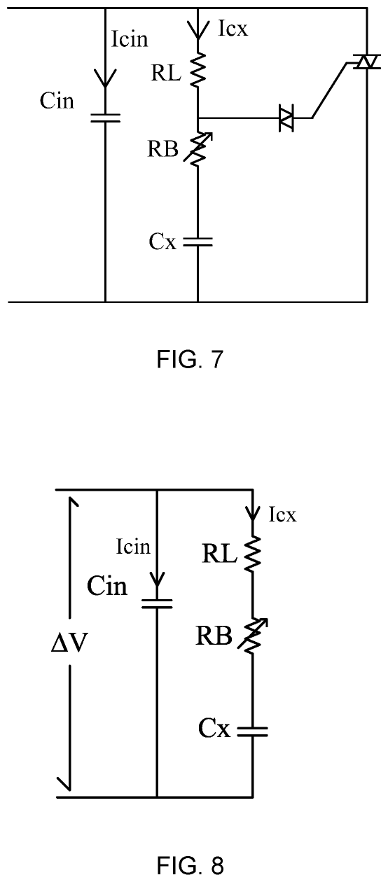

Further, the control module 400 is configured to control the discharge module 300 to be turned on when the voltage detection signal V1 is less than a second threshold voltage VREF2, control the discharge module 300 to be turned off when the voltage detection signal V1 is greater than the second threshold voltage VREF2, and when the voltage detection signal V1 is again less than a first threshold voltage VREF1, and control the continuous on of the discharge module 300, and a discharge current occurred when the discharge module 300 is on is greater than the charging current which is the maximum charging current before the silicon-controlled dimmer 100 is turned on. Please refer to FIG. 7 and FIG. 8 together. FIG. 7 is the equivalent diagram of the silicon-controlled dimmer 100. When the silicon-controlled dimmer 100 is not on, the thyristor does not turn on and no current passes through, that is, the equivalent diagram before the silicon-controlled dimmer 100 turns on. As shown in FIG. 8, before the silicon-controlled dimmer 100 is turned on, input AC to charge the capacitor Cₓ through the resistor RL and the resistor RB. The conduction condition of the silicon-controlled dimmer 100 is that the voltage of the capacitor Cₓ reaches an on threshold. When a voltage difference at both ends of the capacitor Cₓ reaches a certain threshold, the silicon-controlled dimmer 100 is turned on. The time of the voltage difference at both ends of the capacitor Cₓ can be changed by adjusting the RB resistor, thereby changing the phase angle of the silicon-controlled dimmer 100. Before the silicon-controlled dimmer 100 is turned on, the charging current of the silicon-controlled dimmer 100 is Iₜₒₜₐₗ=I_{cin}+I_{cx}. Within a time period of ΔT, the voltage at both ends of the capacitor Cₕ changes by ΔV, then the equivalent current is: I_{cin}=(ΔV*Cᵢₙ)/ΔT, I_{cx}==ΔV/(ΔT/Cₓ+Rb+RL), in which I_{cin} is the charging current of the capacitor Cᵢₙ and Cᵢₙ is the capacitance value of the capacitor Cᵢₙ, the I_{cx} is the charging current of the capacitor Cₓ, Cₓ is the capacitance value of the capacitor Cₓ, Rb is the resistor value of the resistor Rb, and RI is the resistor value of the resistor RL, that is, the maximum charging current value of the silicon-controlled dimmer 100 before it is turned on is the maximum value of Iₜₒₜₐₗ, that is, the discharge current, when the discharge module 300 is turned on, is greater than the total maximum value of Iₜₒₜₐₗ.

The first threshold voltage VREF1 is less than or equal to the second threshold voltage VREF2. When the line voltage rises, if the line voltage is less than the second threshold voltage VREF2, that is, the voltage detection signal V1 is less than the second threshold voltage VREF2, the silicon-controlled dimmer 100 is turned on, the control module 400 outputs the corresponding control signal to the discharge module 300, and the discharge module 300 is turned on for current discharge, When the line voltage continues to rise to be greater than the second threshold voltage VREF2, that is, at this time, the voltage detection signal V1 is greater than the second threshold voltage VREF2, at this time, the control module 400 controls the discharge module 300 to be closed, and then if the line voltage falls below the on-voltage of the LED lamp string 10, the LED lamp string 10 does not light up, the control module 400 does not immediately turn on the discharge module 300, but controls the discharge module 300 to turn on for discharge when the line voltage is less than the first threshold voltage VREF1, which reduces a part of the current compared with the existing circuit, so as to improve the luminous efficiency of the LED lamp string 10. The first threshold voltage VREF1 is less than or equal to the second threshold voltage VREF2.

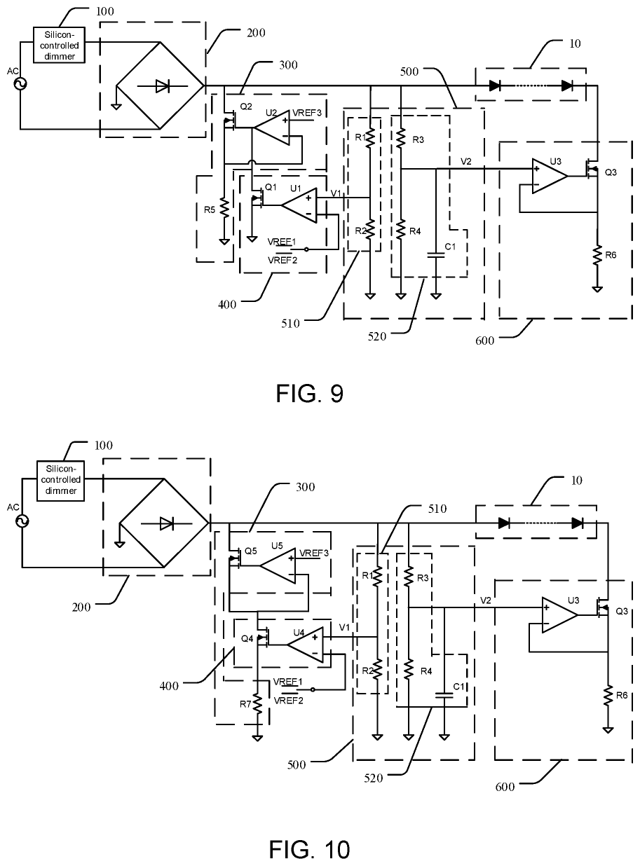

Further, referring to FIG. 9, the voltage detection module 500 includes a voltage detection unit 510 and a phase angle detection unit 520, the voltage detection unit 510 is connected with the control module 400, the rectifier module 200 and the phase angle detection unit 520, and the phase angle detection unit 520 is also connected with the constant current source module 600. The voltage detection unit 510 is configured to output a voltage detection signal V1 to the control module 400 according to the change of the line voltage. The phase angle detection unit 520 is configured to output the phase angle detection signal V2 to the constant current source module 600 according to the change of the line voltage, detect the change of the line voltage through the voltage detection unit 510, and output the voltage detection signal V1 to the control module 400, so that the control module 400 controls the working state of the discharge module 300, so as to improve the luminous efficiency of the LED lamp string 10. At the same time, the phase angle detection unit 520 is configured to detect the phase angle of the silicon-controlled dimmer 100 when the LED lamp string 10 is on, so that the constant current source module 600 can adjust the constant current value of the LED lamp string 10, so as to solve the problem of small phase angle lamp flicker.

In one implementation, the voltage detection unit 510 includes a first resistor R1 and a second resistor R2, one end of the first resistor R1 is connected with the rectifier module 200 and the LED lamp string 10, another end of the first resistor R1 is connected with one end of the second resistor R2 and the control module 400, and another end of the second resistor R2 is grounded. The first resistor R1 and the second resistor R2 are voltage dividing resistors. After voltage dividing and sampling the line voltage through the first resistor R1 and the second resistor R2, the voltage detection signal V1 is obtained, and then the voltage detection signal V1 is output to the control module 400, so that the control module 400 can flexibly control the on and off of the discharge module 300 according to the voltage detection signal V1.

Further, please continue to refer to FIG. 9. In the first embodiment of the present disclosure, the phase angle detection unit 520 includes a third resistor R3, a fourth resistor R4 and a first capacitor C1. One end of the third resistor R3 is connected with one end of the first resistor R1, the LED lamp string 10 and the rectifier module 200, and another end of the third resistor R3 is connected with one end of the fourth resistor R4, one end of the first capacitor C1 and the constant current source module 600, another end of the fourth resistor R4 and another end of the first capacitor C1 are grounded. The third resistor R3 and the fourth resistor R4 are voltage dividing resistors, and the first capacitor C1 is a filter capacitor for filtering the phase angle detection signal V2 and outputting the same to the constant current source module 600. The phase cutting process of the silicon-controlled dimmer 100 is to change an effective value of the line voltage, obtain the sampling voltage through the partial voltage sampling of the line voltage by the third resistor R3 and the fourth resistor R4 to characterize the on phase angle of the silicon-controlled dimmer 100, that is, detect the phase angle detection signal V2. The constant current value is adjusted by detecting the effective value of the line voltage, i.e., the phase angle detection signal V2, to effectively solve the problem of small phase angle lamp flicker.

In the present embodiment, the control module 400 includes a first operational amplifier U1 and a first MOS transistor Q1, an non-invert input end of the first operational amplifier U1 is connected with the other end of the first resistor R1 and the one end of the second resistor R2, an invert input end of the first operational amplifier U1 is connected with a power supply end, and an output end of the first operational amplifier U1 is connected with a gate of the first MOS transistor Q1, a drain of the first MOS transistor Q1 is connected to the discharge module 300, a source of the first MOS transistor Q1 is grounded, the non-invert input end of the first operational amplifier U1 inputs the voltage detection signal V1, and the inverted input end of the first operational amplifier U1 inputs the second threshold voltage VREF2. When the line voltage rises, the first operational amplifier U1 compares the voltage detection signal V1 with the second threshold voltage VREF2. If the voltage detection signal V1 is less than the second threshold voltage VREF2, the first MOS transistor Q1 is controlled to be on through the output end to form a pull-down current to the ground. At the same time, the discharge module 300 is turned on for discharging, the discharge current at this time is greater than the charging current value which is the maximum charging current value before the silicon-controlled dimmer 100 is turned on, wherein the pull-down current value is greater than the maximum current value for charging the capacitor in the silicon-controlled dimmer 100 before the silicon-controlled dimmer 100 is turned on, so that the change of the line voltage can be determined by the charging current of the silicon-controlled dimmer 100 before it is turned on, Further, it is ensured that the maximum phase angle is determined by the silicon-controlled dimmer 100 itself.

Then, when the first operational amplifier U1 compares that the voltage detection signal V1 is greater than the second threshold voltage VREF2, it controls the first MOS transistor Q1 to be turned off, and then controls the discharge module 300 to be turned off. Set the comparison-voltage of the first operational amplifier U1 to the first threshold voltage VREF1, that is, if the first operational amplifier U1 compares again that the voltage detection signal V1 is less than the first threshold voltage VREF1, control the discharge module 300 to be on for discharging, and discharge with a present fixed current without closing the discharge module 300, to facilitate the complete discharge of the capacitor in the silicon-controlled dimmer 100 and avoid the lamp flicker caused by the inconsistent on voltage of the silicon-controlled dimmer 100 due to the incomplete discharge of the capacitor in the silicon-controlled dimmer 100. At the same time, by setting the first threshold voltage VREF1 and the second threshold voltage VREF2, the discharge module 300 can be controlled to be on or off under certain conditions, that is, after the lamp of the discharge module 300 is off, it can be turned on again when the line voltage is lower than the first threshold voltage VREF1 without being turned off, so as to improve the luminous effect of the LED lamp string 10.

Further, in the present embodiment, the discharge module 300 includes a second operational amplifier U2, a second MOS transistor Q2 and a fifth resistor R5, a non-invert input end of the second operational amplifier U2 is connected with a power supply, and an invert input end of the second operational amplifier U2 is connected with a source of the second MOS transistor Q2 and one end of the fifth resistor R5, an output end of the second operational amplifier U2 is connected with a gate of the second MOS transistor Q2 and a drain of the first MOS transistor Q1, another end of the fifth resistor R5 is grounded. The discharge module 300 is a constant current source with the same structure as the constant current source module 600. After the discharge module 300 is turned on, the output current can be adjusted by adjusting the voltage VREF3 input to the non-invert input end of the second operational amplifier U2, that is, the discharge current of the discharge module 300 can be adjusted to ensure that when the discharge module 300 is turned on the discharge current is greater than the charging current which is the maximum charging current before the silicon-controlled dimmer 100 is turned on.

Further, the constant current source module 600 includes a third operational amplifier U3, a third MOS transistor Q3 and a sixth resistor R6. An non-invert input end of the third operational amplifier U3 is connected with the other end of the third resistor R3, the one end of the fourth resistor R4 and the one end of the first capacitor C1, the inverted input end of the third operational amplifier U3 is connected with a source of the third MOS transistor Q3 and one end of the sixth resistor R6, the output end of the third operational amplifier U3 is connected with a gate of the third MOS transistor Q3, a drain of the third MOS transistor Q3 is connected with the LED lamp string 10, and another end of the sixth resistor R6 is grounded. The phase angle detection signal V2 is input to the non-invert input end of the third operational amplifier U3. By detecting the effective value of the line voltage, the input value of the output operational amplifier of the third operational amplifier U3 is directly adjusted, and then the constant current value is adjusted to reduce the influence of the on-voltage of the silicon-controlled dimmer 100 and solve the problem of small phase angle lamp flicker.

In the second embodiment of the present disclosure, please refer to FIG. 10. The control module 400 includes a fourth operational amplifier U4 and a fourth MOS transistor Q4, the discharge module 300 includes a fifth operational amplifier U5, a fifth MOS transistor Q5 and a seventh resistor R7, and an non-invert input end of the fourth operational amplifier U4 is connected with the other end of the first resistor R1 and the one end of the second resistor R2, an inverted input end of the fourth operational amplifier U4 is connected with a power supply end, an output end of the fourth operational amplifier U4 is connected with a control end of the fourth MOS transistor Q4, a source of the fourth MOS transistor Q4 is connected with one end of the seventh resistor R7, and another end of the seventh resistor R7 is grounded. A drain of the fourth MOS transistor Q4 is connected with an inverted input of the fifth operational amplifier U5 and the source of the fifth MOS transistor Q5, an output end of the fifth operational amplifier U5 is connected with a gate of the fifth MOS transistor Q5, and a drain of the fifth MOS transistor Q5 is connected with the rectifier module 200. If the fourth operational amplifier U4 compares that the voltage detection signal V1 is less than the second threshold voltage VREF2, control the fourth MOS transistor Q4 to be turned on, and then controls the discharge module 300 to be turned on for discharging. If the fourth operational amplifier U4 compares that the voltage detection signal V1 is greater than the second threshold voltage VREF2, control the fourth MOS transistor Q4 to be turned off, and then control the discharge module 300 to be turned off. After that, the comparison-voltage of the fourth operational amplifier U4 is the first threshold voltage VREF1, after comparing that the voltage detection signal V1 falls back to be less than the first threshold voltage VREF1, the discharge module 300 is kept to be on, and the discharge is carried out at a fixed current value and is no longer turned off, so as to improve the luminous efficiency of the LED lamp string 10. The discharge module 300 is a constant current source with the same structure as the constant current source module 600. After the discharge module 300 is turned on, the output current can be adjusted by setting the voltage value VREF3 at the non-invert input end of the sixth operational amplifier U6, that is, the discharge current of the discharge module 300 can be realized.

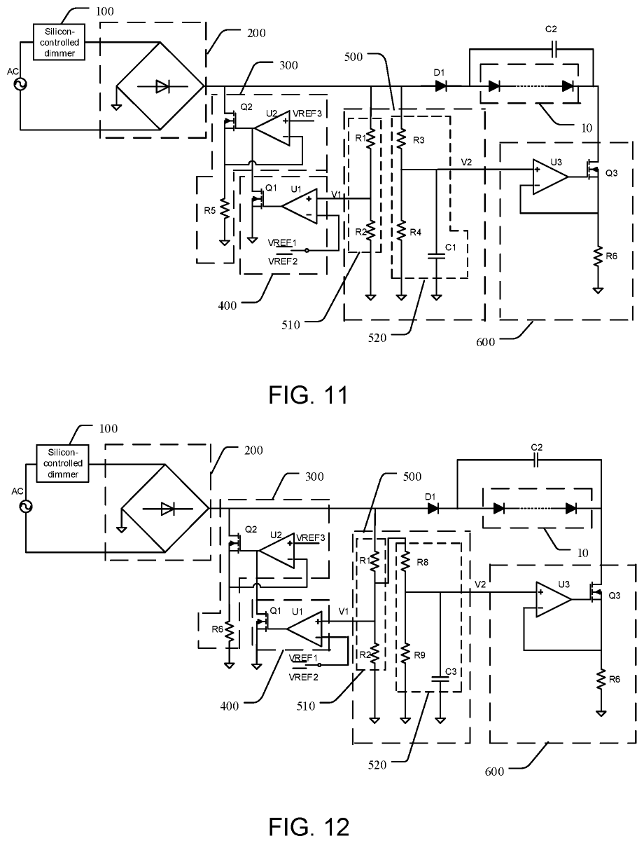

In the third embodiment of the present disclosure, referring to FIG. 11, the LED control circuit compatible with the silicon-controlled dimmer 100 also includes a second capacitor C2 and a first diode D1, one end of the second capacitor C2 is connected with a negative pole of the first diode D1 and the input end of the LED lamp string 10, and another end of the second capacitor C2 is connected with the output end of the LED lamp string 10, a positive pole of the first diode D1 is connected with the rectifier module 200. By connecting a capacitor in parallel with the LED lamp string 10 and connecting a diode at the input end of the LED lamp string 10, it can ensure that the LED lamp string 10 do not flicker.

In the fourth embodiment of the present disclosure, please refer to FIG. 12. The phase angle detection unit 520 includes an eighth resistor R8, a ninth resistor R9 and a third capacitor C3. One end of the eighth resistor R8 is connected with the one end of the first resistor R1, the LED lamp string 10 and the rectifier module 200, and another end of the eighth resistor R8 is connected with one end of the ninth resistor R9, one end of the third capacitor C3 and the non-invert input end of the third operational amplifier U3, another end of the ninth resistor R9 and another end of the third capacitor C3 are grounded. The phase angle detection unit 520 detects the effective value of the line voltage, that is, the phase angle detection signal V2, and send the same to the non-invert input end of the third operational amplifier U3, to further realize the adjustment of the constant current value of the constant current source module 600, reduce the influence of the on-voltage of the silicon-controlled dimmer 100, and solve the problem of small phase angle lamp flicker.

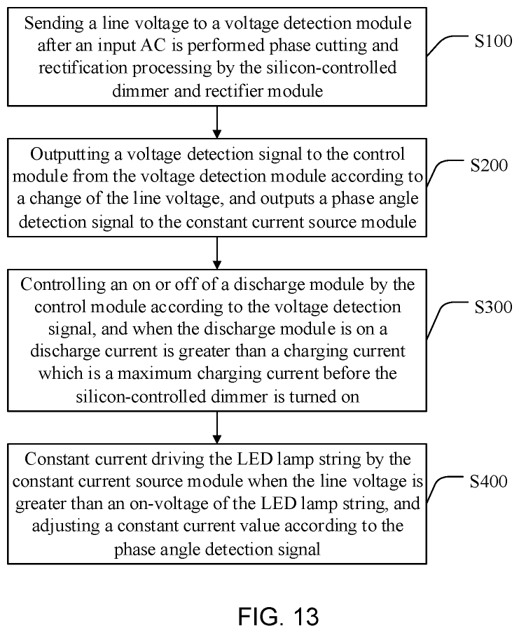

Accordingly, the present disclosure also provides an LED control method compatible with silicon-controlled dimmer, as shown in FIG. 13, which comprises the following steps:

S100. Sending a line voltage to a voltage detection module after an input AC is performed phase cutting and rectification processing by the silicon-controlled dimmer and rectifier module;

S200. Outputting a voltage detection signal to the control module from the voltage detection module according to a change of the line voltage, and outputs a phase angle detection signal to the constant current source module;

S300. Controlling an on or off of a discharge module by the control module according to the voltage detection signal, and when the discharge module is on a discharge current is greater than a charging current which is a maximum charging current before the silicon-controlled dimmer is turned on;

S400. Constant current driving the LED lamp string by the constant current source module when the line voltage is greater than an on-voltage of the LED lamp string, and adjusting a constant current value according to the phase angle detection signal.

The present disclosure also correspondingly provides an LED control device compatible with silicon-controlled dimmer, including a shell, a PCB arranged in the shell, and the PCB is provided with the LED control circuit compatible with silicon-controlled dimmer as described above. Since the LED control circuit compatible with silicon-controlled dimmer has been introduced in detail above, it is not to be described in detail again.

The LED control circuit and the device compatible with silicon-controlled dimmer, and the control method provided by the present disclosure includes a silicon-controlled dimmer, a rectifier module, a discharge module, a control module, a voltage detection module and a constant current source module, an input AC is performed phase cutting and rectification processing by the silicon-controlled dimmer and the rectifier module, and then the output line voltage is sent to the voltage detection module. The voltage detection module is used for outputting a voltage detection signal to the control module according to the change of the line voltage, and outputting a phase angle detection signal to the constant current source module. The control module is configured to control an on or off of the discharge module according to the voltage detection signal, and when the discharge module is on a discharge current is greater than the charging current which is the maximum charging current before the silicon-controlled dimmer is turned on. The constant current source module is used for constant current driving the LED lamp string when the line voltage is greater than an on-voltage of the LED lamp string, and adjusting the constant current value according to the phase angle detection signal. The present disclosure can make a discharge circuit not be on immediately when the LED lamp string is no longer lit, so as to improve a luminous efficiency of the LED lamp string. At the same time, it can also solve a problem of small phase angle lamp flicker when the LED lamp string is lit.

It can be understood that for those skilled in the art, equivalent replacement or changes can be made according to the technical scheme of the present disclosure and its creative concept, and all these changes or replacements should belong to the protection scope of the claims attached to the present disclosure.

1. An LED control circuit compatible with a silicon-controlled dimmer, which is connected with an LED lamp string, comprising a silicon-controlled dimmer and a rectifier module, further comprising a discharge module, a control module, a voltage detection module and a constant current source module;
wherein an input AC is performed phase cutting and rectification processing by the silicon-controlled dimmer and the rectifier module, and then a line voltage is output to the voltage detection module;
wherein the voltage detection module is configured to output a voltage detection signal to the control module according to a change of the line voltage, and output a phase angle detection signal to the constant current source module;
wherein the control module is configured to control an on or off of the discharge module according to the voltage detection signal, and when the discharge module is on the discharge current is greater than a charging current which is a maximum charging current before the silicon-controlled dimmer is turned on; and
wherein the constant current source module is configured to constant current drive the LED lamp string when the line voltage is greater than an on-voltage of the LED lamp string, and adjust a constant current value according to the phase angle detection signal.

2. The LED control circuit compatible with a silicon-controlled dimmer according to claim 1, wherein the control module is configured to control the discharge module to be turned on when the voltage detection signal is less than a second threshold voltage, control the discharge module to be turned off when the voltage detection signal is greater than the second threshold voltage, and when the voltage detection signal is again less than a first threshold voltage, control the discharge module to be turned on;
wherein the first threshold voltage is less than or equal to the second threshold voltage.

3. The LED control circuit compatible with a silicon-controlled dimmer according to claim 1, wherein the voltage detection module comprises a voltage detection unit and a phase angle detection unit, and the voltage detection unit is configured to output the voltage detection signal to the control module according to the change of the line voltage;
wherein the phase angle detection unit is configured to output the phase angle detection signal to the constant current source module according to the change of the line voltage.

4. The LED control circuit compatible with a silicon-controlled dimmer to claim 3, wherein the voltage detection unit comprises a first resistor and a second resistor, one end of the first resistor is connected with the rectifier module and the LED lamp string, another end of the first resistor is connected with one end of the second resistor and the control module, and another end of the second resistor is grounded.

5. The LED control circuit compatible with a silicon-controlled dimmer according to claim 4, wherein the phase angle detection unit comprises a third resistor, a fourth resistor and a first capacitor, one end of the third resistor is connected with one end of the first resistor, the LED lamp string and the rectifier module, another end of the third resistor is connected with one end of the fourth resistor, one end of the first capacitor and the constant current source module, and another end of the fourth resistor and another end of the first capacitor are grounded.

6. The LED control circuit compatible with a silicon-controlled dimmer according to claim 4, wherein the control module comprises a first operational amplifier and a first MOS transistor, a non-invert input end of the first operational amplifier is connected with the other end of the first resistor and one end of the second resistor, an invert input end of the first operational amplifier is connected with a power supply end, an output end of the first operational amplifier is connected with a gate of the first MOS transistor, a drain of the first MOS transistor is connected with the discharge module, and a source of the first MOS transistor is grounded.

7. The LED control circuit compatible with a silicon-controlled dimmer according to claim 6, wherein the discharge module comprises a second operational amplifier, a second MOS transistor and a fifth resistor, a non-invert input end of the second operational amplifier is connected with a power supply, an invert input end of the second operational amplifier is connected with a source of the second MOS transistor and one end of the fifth resistor, an output end of the second operational amplifier is connected with a gate of the second MOS transistor and the drain of the first MOS transistor, and another end of the fifth resistor is grounded.

8. The LED control circuit compatible with a silicon-controlled dimmer according to claim 5, wherein the constant current source module comprises a third operational amplifier, a third MOS transistor and a sixth resistor, a non-invert input end of the third operational amplifier is connected with the other end of the third resistor, the one end of the fourth resistor and the one end of the first capacitor, an invert input end of the third operational amplifier is connected with a source of the third MOS transistor and one end of the sixth resistor, an output end of the third operational amplifier is connected with a gate of the third MOS transistor, a drain of the third MOS transistor is connected with the LED lamp string, and another end of the sixth resistor is grounded.

9. A method to control the LED control circuit compatible with silicon-controlled dimmer according to claim 1, comprising a plurality of steps:
sending a line voltage to a voltage detection module after an input AC is performed phase cutting and rectification processing by the silicon-controlled dimmer and rectifier module;
outputting a voltage detection signal to the control module from the voltage detection module according to a change of the line voltage, and outputs a phase angle detection signal to the constant current source module;
controlling an on or off of a discharge module by the control module according to the voltage detection signal, and when the discharge module is on a discharge current is greater than a charging current which is a maximum charging current before the silicon-controlled dimmer is turned on; and
constant current driving the LED lamp string by the constant current source module when the line voltage is greater than an on-voltage of the LED lamp string, and adjusting a constant current value according to the phase angle detection signal.

10. An LED control device compatible with a silicon-controlled dimmer, comprising a shell, and a PCB arranged in the shell, wherein the LED control circuit compatible with a silicon-controlled dimmer according to claim 1 is arranged on the PCB.
